(19) United States
(12) Patent Application Publication
(10) Pub. No.: US 2023/0404224 A1
(43) Pub. Date: Dec. 21, 2023

(54) FRAGRANCE DISPENSING EARRINGS

(71) Applicant: Rosa Rodriguez-Sdassi, bristol, CT (US)

(72) Inventor: Rosa Rodriguez-Sdassi, Bristol, CT (US)

(73) Assignee: rosa rodriguez-sdassi, bristol, CT (US)

(21) Appl. No.: 18/203,448

(22) Filed: May 30, 2023

Related U.S. Application Data
(60) Provisional application No. 63/473,451, filed on May 31, 2022.

(51) Int. Cl. A44C 15/00; B05B 15/60; A44C 7/00

(52) U.S. Cl. CPC A44C 15/002; B05B 15/60; A44C 7/00

(57) ABSTRACT

A pair of fragrance emitting earrings are disclosed. Each earring includes a main body, atomizer, attachment element, and cap. The main body may include a reservoir positioned therein that stores a liquid. The atomizer can be fluidically coupled to the reservoir and reduce the liquid to a spray when compressed. The cap can demountably couple to the main body. The cap can cover the atomizer when coupled to the main body. The attachment element can couple to and extend from the cap. The attachment element can be configured to demountably attach to an ear of a user. Each earring can further include an access port. The access port can be positioned proximate to the bottom end. The access port can be fluidically coupled to the reservoir. The access port can selectively receive the liquid from a container that includes a stem through which the liquid is dispensed.

### CROSS-REFERENCE TO RELATED APPLICATIONS

This application claims priority to U.S. Provisional Application No. 63/473,451 filed May 31, 2022. The application is hereby incorporated herein by reference.

### BACKGROUND

The instant disclosure relates generally to jewelry and specifically to fragrance dispensing earrings. An earring is a piece of jewelry attached to the ear via a piercing in the earlobe or another external part of the ear (except in the case of clip earrings, which clip onto the lobe). Earrings have been worn by people in different civilizations and historic periods, often with cultural significance. An aroma compound, also known as an odorant or fragrance, is a chemical compound that has a smell or odor. Aroma compounds can naturally be found in various foods, such as fruits and their peels, wine, spices, floral scent, perfumes, fragrance oils, and essential oils.

A fragrance is typically stored in a bulky bottle that is not well suited for everyday carry outside of the home and typically requires the use of a bag or large pocket for storage. The consumer would benefit from a solution that allows the use of a fragrance for everyday carry that does not require the use of a bag or large pocket.

### BRIEF DESCRIPTION OF THE DRAWINGS

FIG. 1 depicts a front view of a fragrance dispensing earring in a “closed state”, in accordance with some embodiments.

FIG. 2 depicts a front view of the fragrance dispensing earring in an “open state,” in accordance with other embodiments.

FIG. 3 depicts a bottom perspective view of the fragrance dispensing earring, in accordance with certain embodiments.

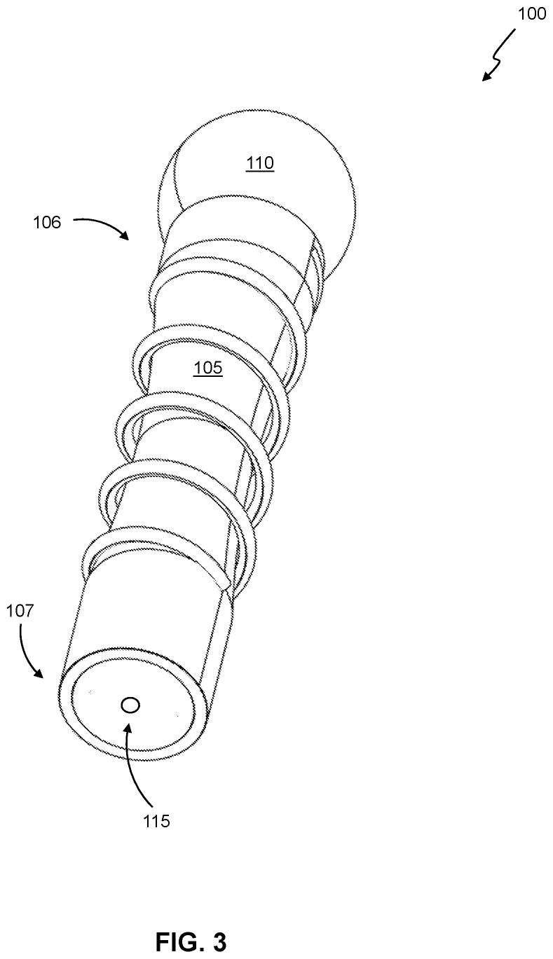

FIG. 4 depicts a front view of a main body of the fragrance dispensing earring, in accordance with certain embodiments.

FIG. 5 depicts a front view of an atomizer of the fragrance dispensing earring, in accordance with some embodiments.

FIG. 6 depicts a front view of an access port of the fragrance dispensing earring, in accordance with other embodiments.

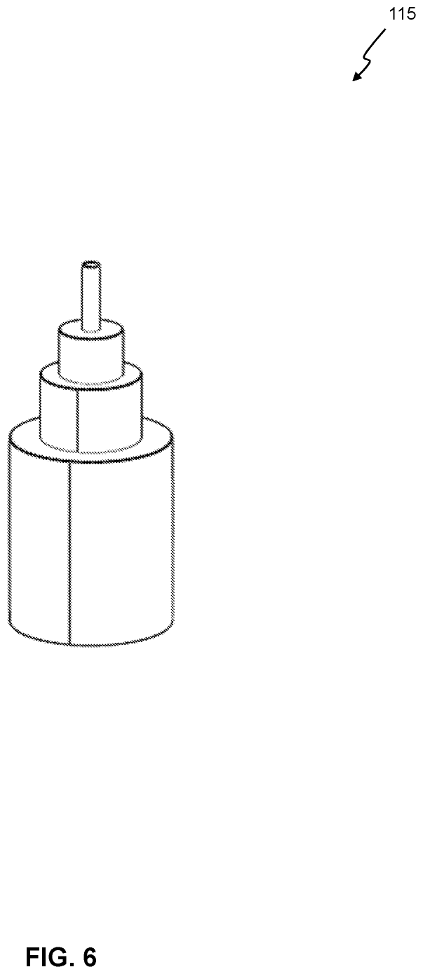

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain terminology may be employed in the following description for convenience rather than for any limiting purpose. For example, the terms “forward” and “rearward,” “front” and “rear,” “right” and “left,” “upper” and “lower,” and “top” and “bottom” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “horizontal” and “axial” or “vertical” referring, respectively, to directions or planes which are perpendicular, in the case of radial or horizontal, or parallel, in the case of axial or vertical, to the longitudinal central axis of the referenced element, the terms “proximate” and “distal” referring, respectively, to positions or locations that are close or away from a point of reference, and the terms “downstream” and “upstream” referring, respectively, to directions in and opposite that of fluid flow. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows. Angles may be designated as “included” as measured relative to surfaces or axes of an element and as defining a space bounded internally within such element therebetween, or otherwise without such designation as being measured relative to surfaces or axes of an element and as defining a space bounded externally by or outside of such element therebetween. Generally, the measures of the angles stated are as determined relative to a common axis, which axis may be transposed in the figures for purposes of convenience in projecting the vertex of an angle defined between the axis and a surface which otherwise does not extend to the axis. The term “axis” may refer to a line or to a transverse plane through such line as will be apparent from context.

The instant disclosure relates generally to jewelry and specifically to fragrance dispensing earrings. An earring is a piece of jewelry attached to the ear via a piercing in the earlobe or another external part of the ear (except in the case of clip earrings, which clip onto the lobe). Earrings have been worn by people in different civilizations and historic periods, often with cultural significance. An aroma compound, also known as an odorant or fragrance, is a chemical compound that has a smell or odor. Aroma compounds can naturally be found in various foods, such as fruits and their peels, wine, spices, floral scent, perfumes, fragrance oils, and essential oils.

A fragrance is typically stored in a bulky bottle that is not well suited for everyday carry outside of the home and typically requires the use of a bag or large pocket for storage. The consumer would benefit from a solution that allows the use of a fragrance for everyday carry that does not require the use of a bag or large pocket.

Embodiments of the instant disclosure seek to provide fragrance dispensing earrings. Other aspects of the present disclosure seek to provide fragrance dispensing earrings that can be refilled.

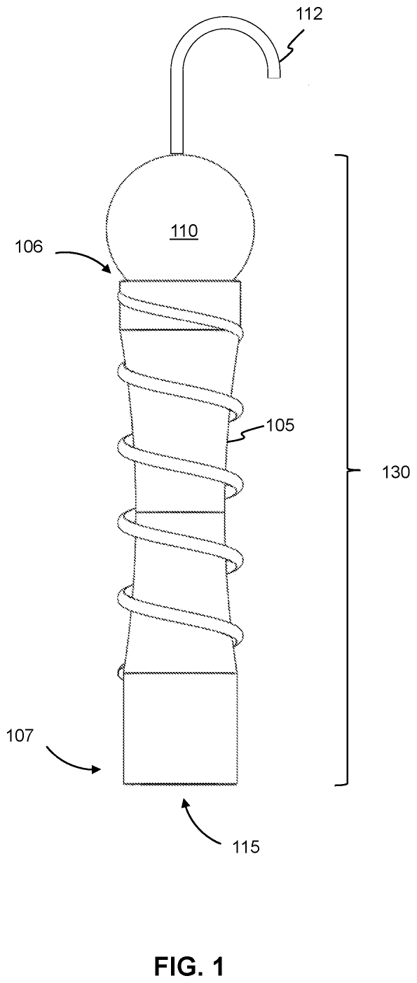

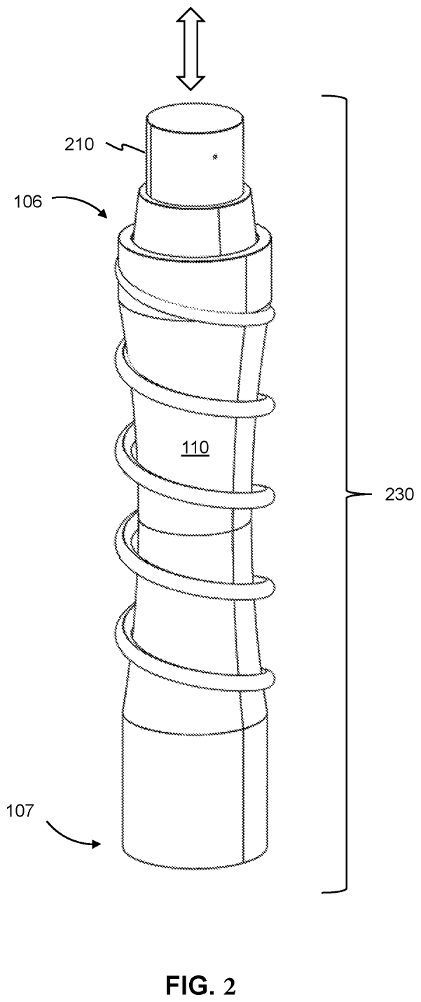

Turning now to the Figures. FIG. 1 depicts a front view of a fragrance dispensing earring, generally 100, in “closed state” 130, according to some embodiments. To be sure, the earring 100 includes two modes of operation, the closed state 130 and an open state 230 (depicted in FIG. 2). Carrying bulky fragrance bottles outside of the house is not convenient. For example, when traveling away from home, a bag (e.g., purse, backpack, messenger bag, luggage, etc.) is typically required to hold a bulky fragrance bottle. To address this dilemma, a user can utilize the earring 100, which is configured to store a fragrance (or other volatile liquid) internally and thereby eliminate the need to store the bulky item.

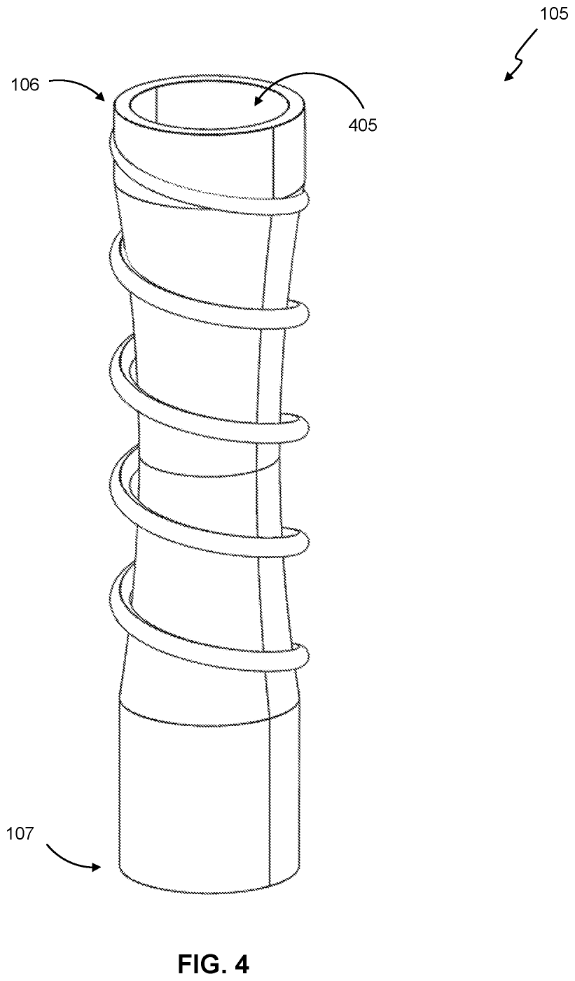

The earring 100 includes a main body 105, an atomizer 405, an attachment element 112, an access port 115, and a cap 110. Two or more components of the earring 100 can be coaxially aligned. One or more components of the earring 100 can be made of a metal, a fabric, a polymer, and/or glass. One or more components of the earring 100 can be formed by milling, casting, additive printing, or similar manufacturing methods. The main body 105 includes a top end 106 and a bottom end 107 that is positioned opposite the top end 106. The main body 105 is a hollow structure that includes a reservoir 405 (depicted in FIG. 4) positioned therein that stores a liquid (e.g., a fragrance or other liquid). The main body 105 can be structurally polygonal and/or ovular. In some embodiments, the reservoir 405 and the main body 105 can be two separate components. The cap 110 can demountably couple to the main body 105 and thereby cover the atomizer 405 when coupled thereto. The cap 110 can be structurally polygonal and/or ovular. The cap 110 can be hinged and/or rotationally attached to the main body 105. The cap 110 can be positioned proximate to the top end 106. The attachment element 112 can be coupled to and extend from the cap 110.

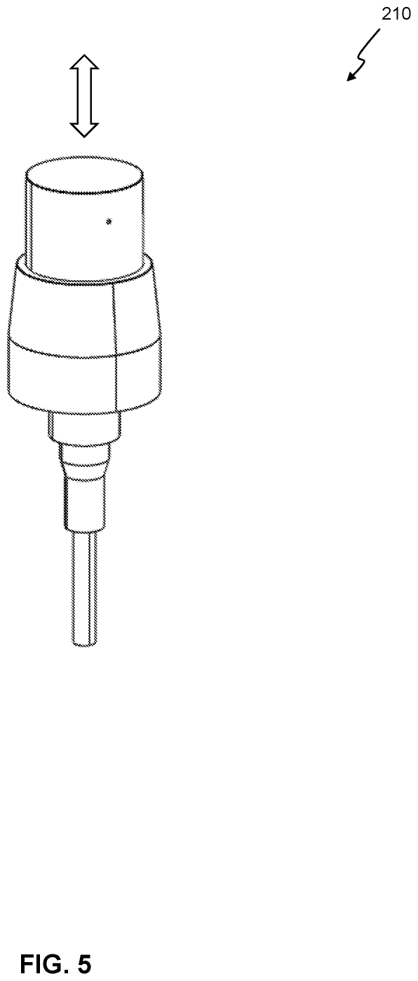

The attachment element 112 is configured to demountably attach to an ear of the user. The attachment element 112 can include a post, a kidney wire, a hook, or a demountable fastener (e.g., a clip). The attachment element 112 and the cap 110 can be formed as two separate components that are attached together, or they can be formed as a single component. Although the earring 100 can be configured to be single use, the earring 100 can also be configured to be refillable. For example, the earring 100 may also include an access port 115 that can be positioned proximate to the bottom end 107. The access port 115 is fluidically coupled to the reservoir 505. The access port 115 selectively receives the liquid from a container that comprises a stem through which the liquid is dispensed (e.g., a perfume bottle or a cologne bottle known in the art). The stem of the container can be exposed and inserted into the access port 115 to allow the liquid to traverse the access point 115 and collect within the reservoir 405. In other words, the access port 115 can receive the stem and thereby direct the liquid stored therein (e.g., under pressure or inertly) into the reservoir 405. The atomizer 210 is fluidically coupled to the reservoir 505 and reduces the liquid to a spray when compressed. As depicted in FIG. 5, the atomizer 210 can be an apparatus known in the art that can convert a liquid to a fine mist or spray.

In the closed state 130, the earring 100 can be worn by the user. In the closed state 130, the cap 110 can demountably couple to the main body 105 to cover the atomizer 210 and thereby prevent the atomizer 210 from being compressed. In the open state 230, the earring 100 can be used to dispense the fragrance stored in the reservoir 405. In the open state 130, the cap 110 can be decoupled (completely or partially) from the main body 105 in a manner to expose the atomizer 210 to be compressed and thereby dispense the liquid as a fine mist or spray.

Based on the foregoing, fragrance dispensing earrings have been disclosed in accordance with the present invention. However, numerous modifications and substitutions can be made without deviating from the scope of the instant disclosure. Therefore, the instant disclosure has been disclosed by way of example and not limitation.

What is claimed is:

1. A pair of earrings, each earring comprising:
a main body;
an atomizer;
an attachment element;
a cap;
wherein
the main body comprises a reservoir positioned therein that stores a liquid;
the atomizer is fluidically coupled to the reservoir and reduces the liquid to a spray when compressed;
the cap
demountably couples to the main body
covers the atomizer when coupled to the main body;
the attachment element is
is coupled to and extends from the cap; and
is configured to demountably attached to an ear of a user.

2. The pair of earrings of claim 1, wherein each earring further comprises:
an access port;
wherein
the access port
is positioned proximate to the bottom end;
is fluidically coupled to the reservoir;
selectively receives the liquid from a container that comprises a stem through which the liquid is dispensed; and
the access port receives the stem.

3. The pair of earrings of claim 2, wherein
one or more of the cap and the main body comprises one or more of a metal, a fabric, and a polymer.

4. The pair of earrings of claim 3, wherein
the main body comprises a top end and a bottom end;
the cap is positioned proximate to the top end; and
the access port is positioned proximate to the bottom end.

5. The pair of earrings of claim 4, wherein the cap is coupled proximate to the top end.

6. The pair of earrings of claim 5, wherein
the attachment elements comprise a post, a kidney wire, a hook, or a demountable fastener.

7. The pair of earrings of claim 6, further comprising:
a closed state;
an open state;
wherein
when in the closed state, the cap is demountably coupled to the main body, covers the atomizer, and thereby prevents the atomizer from being compressed; and
when in the open state,
the cap is decoupled from the main body and thereby exposes the atomizer to be compressed.

8. A method of refilling the earrings of claim 2, comprising:
exposing the stem of the container; and
inserting the stem into the access point to allow the liquid to traverse the access point and collect within the reservoir.
